(19) United States
(12) Patent Application Publication
(10) Pub. No.: US 2026/0014999 A1
(43) Pub. Date: Jan. 15, 2026

(54) APPARATUS AND METHOD FOR ASSISTING DRIVING OF HOST VEHICLE

(71) Applicant: HL MANDO CORPORATION, Pyeongtaek-si (KR)

(72) Inventor: Youngeun CHO, Pyeongtaek-si (KR)

(73) Assignee: HL MANDO CORPORATION, Pyeongtaek-si (KR)

(21) Appl. No.: 19/184,645

(22) Filed: Apr. 21, 2025

(30) Foreign Application Priority Data
Jul. 9, 2024 (KR) 10-2024-0090395

(51) Int. Cl. B60W 50/029; B60W 10/04; B60W 10/184; B60W 40/12; B60W 50/00; B62D 5/00; B62D 9/00

(52) U.S. Cl. CPC B60W 50/029; B60W 10/04; B60W 10/184; B60W 40/12; B62D 9/005; B60W 2050/0022; B60W 2510/20; B60W 2710/18; B60W 2720/10; B62D 5/001

(57) ABSTRACT

The present disclosure provides an apparatus for assisting driving of a host vehicle, including a first sensor configured to detect a first steering angle of a steering wheel of the host vehicle and a controller connected to the first sensor, wherein the controller is configured to, in response to a determination of a failure of a steering system of the host vehicle, steer the host vehicle with a biased brake torque and compensate for a driving torque of the host vehicle, that is reduced due to the biased brake torque.

### CROSS-REFERENCE TO RELATED APPLICATION

This application claims priority to and the benefit from Korean Patent Application No. 10-2024-0090395, filed on Jul. 9, 2024, the disclosures of which are incorporated herein by reference in its entirety.

### BACKGROUND

The present disclosure relates to an apparatus and method for assisting driving of a host vehicle.

A steering assistance system of a vehicle is a system that assists a driver in changing a direction of travel of the vehicle according to his or her will, and is a system that assists the driver in more easily driving the vehicle by generating a steering assistance force in a direction of travel desired by the driver.

The steering assistance systems are implemented as hydraulic power steering apparatuses (HPS), electric power steering apparatuses (EPS), and the like.

In recent years, a steer-by-wire (SBW) steering system in which mechanical connecting devices between a steering wheel and wheels, such as steering columns are eliminated and instead the steering wheel and the wheels are connected through wires and a steering of the vehicle is accomplished by driving a motor has been developed and applied.

However, since the steer-by-wire steering system has no mechanical connection between the steering wheel and the wheels, when there is a problem with communication and a steering signal is not transmitted, the steering performance may be completely lost, which may cause a major accident.

Accordingly, in case a specific configuration included in the system fails, in the recent steering assistance system, a redundancy system in which a configuration identical to the specific configuration is added has been applied, fail safety has been implemented based on the redundancy system, and technological development to more stably implement fail safety is increasingly being made.

However, there is a problem of increasing costs when an additional redundancy system is installed in order to implement redundancy.

### SUMMARY

The present disclosure is directed to implementing redundancy by steering a host vehicle using a biased brake force of a braking system when a steering system fails.

In addition, the present disclosure is directed to compensating for as much driving force as a longitudinal deceleration force of a host vehicle generated by a biased brake force to compensate for the longitudinal deceleration of the host vehicle, and furthermore, allowing a driver to experience natural deceleration without experiencing any discomfort and allowing the driver to safely move the host vehicle to a target position.

Problems to be solved by the present disclosure are not limited to those mentioned above, and other problems not mentioned will be clearly understood by those of ordinary skill in the art to which the present disclosure belongs from the following description.

In order to solve the above-mentioned problems, according to an aspect of the present disclosure, there is provided an apparatus for assisting driving of a host vehicle including a first sensor configured to detect a steering angle of a steering wheel of the host vehicle and a controller connected to the first sensor, wherein the controller is configured to, in response to a determination of a failure of a steering system of the host vehicle, steer the host vehicle with a biased brake torque and compensate for a driving torque of the host vehicle, that is reduced due to the biased brake torque.

The controller may calculate the biased brake torque based on the steering angle and transmit a first signal including information about the biased brake torque to a braking system of the host vehicle.

The braking system may steer the host vehicle based on the biased brake torque.

The controller may calculate the driving torque based on the biased brake torque and provide a second signal including information about the driving torque to a driving system of the host vehicle.

The driving system may control a speed of the host vehicle based on the driving torque.

The controller may calculate the driving torque by applying a weight to the biased brake torque.

The controller may differently determine the weight depending on a speed of the host vehicle.

The controller may determine a plurality of section speeds by dividing a speed of the host vehicle into sections and decrease the weight as the plurality of section speeds increase.

The apparatus may further include a second sensor configured to detect an object in front of the host vehicle.

The controller may be connected to the second sensor and determine a target position of the host vehicle based on the object in front of the host vehicle.

The controller may determine the weight based on the target position.

The controller may increase the weight as a distance between the host vehicle and the target position increases.

The controller may be configured to calculate a target moment of the host vehicle based on the steering angle, calculate a biased brake force based on the target moment, calculate a total braking pressure based on the biased brake force, and calculate a biased brake torque based on the total braking pressure.

The controller may calculate the driving torque based on the biased brake torque.

The steering system may be a steer-by-wire system.

According to another aspect of the present disclosure, there is provided a method of assisting driving of a host vehicle, including determining whether a steering system of the host vehicle fails, in response to a determination of a failure of the steering system of the host vehicle, steering the host vehicle with a biased brake torque, and compensating for a driving torque of the host vehicle, that is reduced due to the biased brake torque.

The steering of the host vehicle may include calculating a target moment of the host vehicle based on a steering angle of a steering wheel of the host vehicle, calculating a biased brake force based on the target moment, calculating a total braking pressure based on the biased brake force, calculating a biased brake torque based on the total braking pressure, and transmitting a first signal including information about the biased brake torque to a braking system.

The compensating for the driving torque of the host vehicle may include calculating the driving torque based on the biased brake torque and providing a second signal including information about the driving torque to a driving system of the host vehicle.

The calculating of the driving torque may include calculating the driving torque by applying a weight to the biased brake torque.

The calculating of the driving torque may include determining a plurality of section speeds by dividing a speed of the host vehicle into sections and decreasing the weight as the plurality of section speeds increase.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a view schematically illustrating a steering system according to an embodiment of the present disclosure;

FIG. 2 is a block diagram of a driver assistance apparatus of a host vehicle according to an embodiment of the present disclosure;

FIG. 3 is a view for describing the operation of the driver assistance apparatus of a host vehicle according to the embodiment of the present disclosure;

FIGS. 4A and 4B are views for describing a scrub radius in relation to a driver assistance apparatus of a host vehicle according to an embodiment of the present disclosure;

FIGS. 5A and 5B are views for describing a front wheel steering angle generated when a biased brake torque is applied;

FIG. 6 is a view for describing a method of calculating a torque factor;

FIG. 7 is a graph for describing a method of compensating for a driving force that is reduced due to steering a host vehicle using a biased brake force by a driving assistance apparatus of a host vehicle according to an embodiment of the present disclosure;

FIG. 8 is a graph for describing a method of setting a weight according to the speed of a host vehicle at a point in time when a steering system fails;

FIG. 9 is a flowchart of a method of assisting a driver of a host vehicle according to an embodiment of the present disclosure;

FIG. 10 is a specific flowchart of an operation of controlling steering of the host vehicle by a braking system in FIG. 9; and

FIG. 11 is a specific flowchart of an operation of controlling the speed of the host vehicle by a driving system in FIG. 9.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

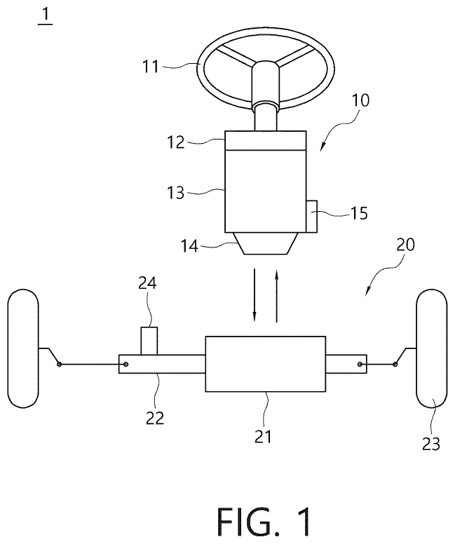

FIG. 1 is a view schematically illustrating a steering system according to an embodiment of the present disclosure.

Referring to FIG. 1, a steering system 1 according to an embodiment of the present disclosure may assist steering power so that a driver may easily steer a host vehicle.

Depending on a driving method, the steering system 1 may include a hydraulic type system (hydraulic power steering (HPS)) that generates hydraulic pressure by rotating a pump to provide steering assistance power, an electric type system (electronic power steering (EPS)) that drives a motor to provide steering assistance power, or the like.

Hereinafter, for convenience, the steering system 1 according to the embodiment of the present disclosure will be described based on the electric type steering system, but is not limited thereto.

The steering system 1 according to the embodiment of the present disclosure may be divided into a mechanical steering system and a steer-by-wire (SbW) steering system depending on whether an input actuator 10 and a steering actuator 20 are connected by a mechanical connecting member.

The mechanical steering system is a steering system in which the input actuator 10 and the steering actuator 20 are mechanically connected through a mechanical connecting member. According to the mechanical steering system, rotational power (torque) generated by a driver turning a steering wheel 11 is transmitted to the steering actuator 20 through a mechanical power transmission device or a mechanical connecting member (e.g., a linkage, a steering shaft, and a universal joint), so that a wheel 23 of the host vehicle may be steered.

The steer-by-wire steering system is a steering system in which the input actuator 10 and the steering actuator 20 are electrically connected through wires, cables, or the like, instead of the mechanical power transmission device. According to the steer-by-wire steering system, the input actuator 10 may detect a steering angle of the steering wheel 11, calculate a steering control value (e.g., a target rack stroke value) for the steering angle, and output an electric signal indicating the steering control value to the steering actuator 20 to drive the steering actuator 20.

The steering system 1 according to the embodiment of the present disclosure will be described as the steer-by-wire system for convenience, but is not limited thereto.

The steering system 1 according to the embodiment of the present disclosure may be configured to include the input actuator 10 and the steering actuator 20.

The steering system 1 according to the embodiment of the present disclosure may have the input actuator 10 and the steering actuator 20 connected by an electrical connecting member such as a wire and a cable.

The input actuator 10 is a steering input device that receives steering information intended by the driver (e.g., a steering angle of the steering wheel 11), generates a corresponding detection signal, and outputs the generated detection signal to the steering actuator 20. The input actuator 10 may be configured to include the steering wheel 11, a steering angle sensor 12, a reaction motor 13, a torque sensor 14, and a steering controller 15.

The steering angle sensor 12 may detect a steering angle generated by turning of the steering wheel 11. Specifically, when the driver turns the steering wheel 11, the steering angle sensor 12 may detect the steering angle, which is a rotation angle of the steering wheel 11, and output a detection signal representing the detected steering angle to the steering controller 15.

The reaction motor 13 may receive a command current from the steering controller 15 and apply a reaction force to the steering wheel 11. Specifically, the reaction motor 13 may receive a command current from the steering controller 15 and output a reaction torque by being driven at a rotation speed indicated by the command current.

The torque sensor 14 may detect the torque generated by the turning of the steering wheel 11. Specifically, when the driver of the host vehicle turns the steering wheel 11, the torque sensor 14 may detect the torque of the steering wheel 11 and output a detection signal representing the detected torque to the steering controller 15. Here, torque may refer to torque generated by a driver's operation of the steering wheel 11.

The steering controller 15 is a device that controls the steering of the host vehicle. Specifically, the steering controller 15 may receive detection signals indicating the steering angle and torque from the steering angle sensor 12 and the torque sensor 14, calculate a steering control value, and output a control signal representing the steering control value to the steering actuator 20.

Here, the steering control value may refer to a target rack stroke value, a target rack position value, or the like.

The steering controller 15 may receive feedback about information on power actually output from the steering actuator 20, calculate a reaction force control value, and output a control signal indicating the reaction force control value to the input actuator 10, thereby providing a steering feeling to the driver.

The steering controller 15 may be implemented by an electronic control unit (ECU). In addition, the steering controller 15 may be included in the input actuator 10 or may be separated as a separate device and disposed in the host vehicle.

The steering actuator 20 is a steering output device that drives the host vehicle to be steered according to a driver's intention.

The steering actuator 20 may be configured to include a steering motor 21, a rack 22, a position sensor 24, and the wheel 23.

The steering motor 21 may move the rack 22 in an axial direction. Specifically, the steering motor 21 may be driven by receiving a control signal indicating a steering control value from the steering controller 15 and may cause the rack 22 to linearly move in the axial direction.

The rack 22 may perform linear movement by driving the steering motor 21, and the wheel 23 may be steered left or right through the linear movement of the rack 22.

The position sensor 24 may detect a position of the rack 22. Specifically, when the rack 22 performs linear movement so that the rack 22 is moved from a position corresponding to a neutral position of the steering wheel 11, the rack position sensor 24 may detect an actual position of the rack 22 and output a detection signal indicating a position detection value of the rack 22 to the steering controller 15.

Here, the position sensor 24 may detect an actual moving speed of the rack 22. That is, the position sensor 24 may detect the position of the rack 22, calculate the moving speed of the rack 22 by differentiating the detected position of the rack 22 with respect to time, and output a detection signal indicating the moving speed value of the rack 22 to the steering controller 15.

The steering actuator 20 according to the embodiment of the present disclosure may further include an electronic control unit (ECU). The steering actuator 20 may receive a control signal from the steering controller 15, check the validity of the control signal, and output the control signal to the steering motor 21.

The steering system 1 according to the embodiment of the present disclosure may further include a steering column, a pinion gear, a vehicle speed sensor for detecting a traveling speed of a vehicle, a steering angle sensor for detecting a steering angle of the wheel 23, a yaw rate sensor for detecting a heading angle of the vehicle, a clutch capable of separating or combining a steering input unit and a steering output unit, and the like.

Meanwhile, unlike the mechanical steering system, in the steer-by-wire steering system, since the input actuator 10 and the steering actuator 20 are electrically connected, when a communication problem occurs and the steering signal is not transmitted to the steering actuator 20, the steering performance may be completely lost, which may cause a major accident.

In order to solve the problem, the present disclosure provides a driver assistance apparatus of a host vehicle that steers the host vehicle using a biased brake force when the steering system 1 fails.

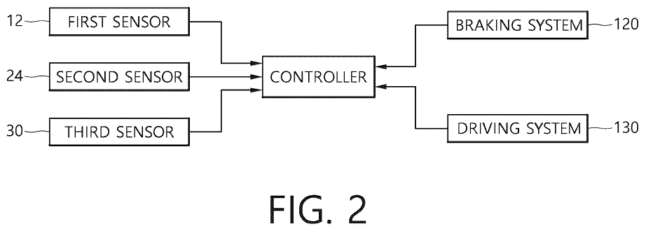

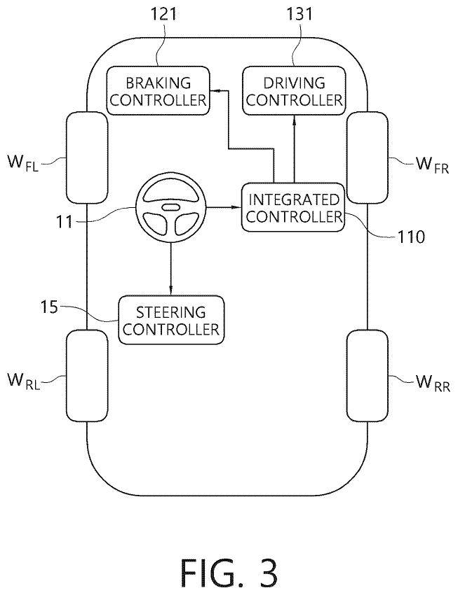

FIG. 2 is a block diagram of a driver assistance apparatus of a host vehicle according to an embodiment of the present disclosure, and FIG. 3 is a view for describing the operation of the driver assistance apparatus of a host vehicle according to the embodiment of the present disclosure.

Referring to FIG. 2, the driver assistance apparatus of a host vehicle according to an embodiment of the present disclosure may be configured to include a first sensor 12, a second sensor 24, a third sensor 30, a controller 110, a braking system 120, and a driving system 130.

The first sensor 12 may detect a first steering angle of the steering wheel 11 of the host vehicle, and the second sensor 24 may detect a second steering angle of a front wheel of the host vehicle or the position of the rack 22 of the steering system 1.

The third sensor 30 may detect an object in front of the host vehicle. Here, the third sensor 30 may be a camera, a radar, a lidar, or an ultrasonic sensor mounted on the host vehicle, but is not limited thereto.

The controller 110 may be communicatively connected to the first sensor 12, the second sensor 24, and the third sensor 30.

The controller 110 may determine whether the steering system 1 of the host vehicle fails based on the first steering angle of the steering wheel 11 and the second steering angle of the front wheel. In addition, the controller 110 may determine whether the steering system 1 of the host vehicle fails based on the first steering angle of the steering wheel 11 and the position of the rack 22 of the steering system 1.

For example, the controller 110 may determine that the steering system 1 fails when the second steering angle of the front wheel or the position of the rack 22 remains the same even though the driver of the host vehicle turns the steering wheel 11 so that the first steering angle is changed.

The controller 110 may steer the host vehicle with a biased brake torque based on the determination that the steering system 1 fails.

Referring to FIG. 3, the driver assistance apparatus of a host vehicle according to the embodiment of the present disclosure may be configured to include a steering controller 15 that controls the steering system 1, a braking controller 121 that controls the braking system 120, a driving controller 131 that controls the driving system 130, and an integrated controller 110 that controls the steering controller 15, the braking controller 121, and the driving controller 131.

The steering controller 15 steers the host vehicle by moving the rack 22 according to the first steering angle of the steering wheel 11. Here, the steering controller 15 may transmit steering failure information to the integrated controller 110 when the steering system 1 fails.

In contrast, the integrated controller 110 may determine whether the steering system 1 fails by receiving information on the first steering angle from the first sensor 12 and information on the second steering angle of the front wheel or the position of the rack 22 from the second sensor 24.

When the integrated controller 110 receives steering failure information from the steering controller 15 or determines that the steering system 1 fails, the integrated controller 110 may provide an audible or visual alarm to limit the driver's will to accelerate and guide the driver to quickly evacuate the host vehicle to prevent an accident due to the failure of the steering system 1.

The integrated controller 110 may calculate a target moment of the host vehicle based on the first steering angle of the steering wheel 11 when the steering system 1 fails, calculate the biased brake torque based on the target moment, and provide the biased brake torque to the braking controller 121.

Accordingly, the braking controller 121 steers the host vehicle by controlling a braking device according to the biased brake torque.

For example, when the steering wheel 11 is turned in a first direction by the first steering angle, the braking controller 121 may steer the host vehicle in the first direction by applying a brake force corresponding to the first steering angle only to the wheel 23 positioned in the first direction.

Accordingly, the driver assistance apparatus of the host vehicle according to the embodiment of the present disclosure may implement redundancy and prevent accidents by steering the host vehicle using the biased brake force of the braking system 120 when the steering system 1 fails, and since there is no need to additionally provide a redundancy actuator to implement redundancy, there is an advantage in terms of cost.

Meanwhile, when steering the host vehicle by applying the biased brake force, a vehicle moment is generated, but since longitudinal deceleration of the host vehicle occurs due to the biased brake force, the speed of the host vehicle quickly decelerates compared to steering in a normal state.

Accordingly, the host vehicle having a broken steering system 1 may not move much and stops, and thus may not reach a target point (e.g., a shoulder) and may cause a rear-end collision with another vehicle.

In order to solve the problem, the present disclosure provides the driver assistance apparatus of a host vehicle that compensates for the driving force reduced due to the biased brake force when steering the host vehicle using the biased brake force.

To this end, the integrated controller 110 may compensate for the driving torque of the host vehicle reduced due to the biased brake torque.

Specifically, the integrated controller 110 may calculate the biased brake torque based on the first steering angle of the steering wheel 11 and provide the biased brake torque to the braking system 120. Accordingly, the braking controller 121 of the braking system 120 may steer the host vehicle by bias-braking the host vehicle based on the biased brake torque.

In addition, the controller 110 may calculate the driving torque based on the biased brake torque and provide the driving torque to the driving system 130. Accordingly, the driving controller 131 of the driving system 130 may control the speed of the host vehicle based on the driving torque.

Meanwhile, a front wheel steering angle generated when the biased brake torque is applied is related to a scrub radius. That is, the front wheel steering angle generated when the biased brake torque is applied may have different characteristics depending on whether the scrub radius is positive or negative.

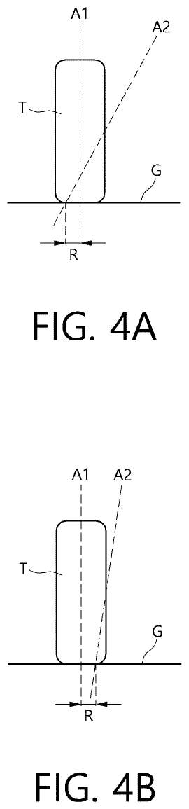

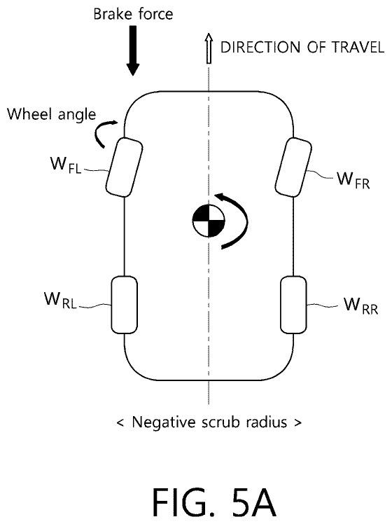

FIGS. 4A and 4B are views for describing a scrub radius in relation to a driver assistance apparatus of a host vehicle according to an embodiment of the present disclosure, and FIGS. 5A and 5B are views for describing a front wheel steering angle generated when the biased brake torque is applied.

Referring to FIGS. 4A and 4B, a scrub radius R is defined as a distance between a point where a vertical center line A1 of a tire T of a wheel meets a road surface G and a point where a center line A2 of a king pin of a vehicle meets the road surface G.

In this case, when an intersection of the vertical center line A1 of the tire T and the center line A2 of the king pin exists on the road surface G, the scrub radius R has a negative value (FIG. 4A). When the intersection of the vertical center line A1 of the tire T and the center line A2 of the king pin exists below the road surface G, the scrub radius R has a positive value (FIG. 4B).

Referring to FIG. 5A, when the scrub radius R has a negative value (a negative scrub radius), the front wheel (W_{FL}, W_{FR}) steering angle (wheel angle) generated when the biased brake torque is applied is in an opposite direction to a vehicle moment direction generated by the biased brake torque. Therefore, the generating of the steering angle may hinder lateral behavior of the host vehicle.

Accordingly, when the scrub radius R has a negative value, it is desirable to provide a reduced driving force due to biased braking only to rear wheels W_{RL} and W_{RR} so as not to disturb the lateral behavior of the host vehicle.

Referring to FIG. 5B, when the scrub radius R has a positive value (a positive scrub radius), the front wheel (W_{FL}, W_{FR}) steering angle (wheel angle) generated when the biased brake torque is applied is in the same direction as the vehicle moment direction generated by the biased brake torque. Therefore, the generating of the steering angle may assist the lateral behavior of the host vehicle.

Accordingly, when the scrub radius R has a positive value, it is desirable to provide a driving force reduced due to biased braking only to the front wheels W_{FL} and W_{FR} to facilitate lateral movement of the host vehicle.

Hereinafter, a method by which the controller 110 calculates the brake torque and driving torque will be described in detail.

First, the controller 110 may calculate a target moment of the host vehicle based on a first steering angle and calculate a biased brake force based on the target moment.

Specifically, a biased brake force Fb may be calculated by the following Equation 1.

$$Fb = \frac{Mt}{( \frac{Wd}{2} )} \qquad < Equation 1 >$$

Here, Mt is a target moment of the host vehicle, and Wd is a width of the host vehicle.

Next, the controller 110 may calculate a total braking pressure based on the biased brake force.

Specifically, a total braking pressure Pb may be calculated by the following Equation 2.

$$Pb = \frac{Fb \cdot Re}{( ff + fr )} \qquad < Equation 2 >$$

Here, Fb is a biased brake force, Re is a tire effective radius, ff is a front wheel torque factor, and fr is a rear wheel torque factor.

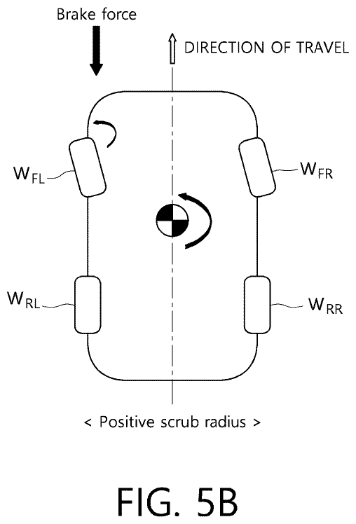

FIG. 6 is a view for describing a method of calculating a torque factor.

A torque factor f may be calculated by the following Equation 3.

$$f = {μ}_{b} \times ( P / A ) \times R \times {N}_{s} \times {N}_{w} \qquad < Equation 3 >$$

Referring to FIG. 6, μ_{b} is a friction coefficient of a brake pad, A and P are an area and a pressure of a region where a cylinder presses the brake pad, R is a tire effective radius, Nₛ is the number of cylinders, and N_{w} is the number of wheels.

Next, the controller 110 may calculate a biased brake torque based on the total braking pressure Pb.

Specifically, the biased brake torques Tbf and Tbr may be calculated by the following Equation 4.

$$Tbf = Pb \cdot ff \qquad < Equation 4 >$$

$$Tbr = Pb \cdot fr$$

Here, Tbf is a front wheel brake torque, Tbr is a rear wheel brake torque, Pb is the total braking pressure, ff is the front wheel torque factor, and fr is the rear wheel torque factor.

Meanwhile, even though the same braking pressure is applied to each of the front and rear wheels, since the sizes of calipers provided on the front and rear wheels are different, the front and rear wheel brake torques are also different. Accordingly, each of the front wheel brake torque and rear wheel torque is calculated.

Next, the controller 110 may calculate the driving torque based on the biased brake torque. Here, the controller 110 may calculate the driving torque by applying a weight to the biased brake torque.

Specifically, a driving torque Td may be calculated by the following Equation 5.

$$Td = ( Tbf + Tbr ) \cdot α \qquad < Equation 5 >$$

Here, Tbf is the front wheel brake torque, Tbr is the rear wheel brake torque, and a is a weighting factor.

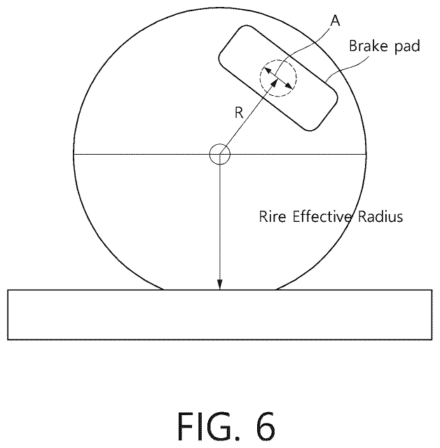

FIG. 7 is a graph for describing a method of compensating for a driving force reduced by steering a host vehicle using a biased brake force by a driving assistance apparatus of a host vehicle according to an embodiment of the present disclosure.

A dotted line shown in the graph of FIG. 7 indicates that the host vehicle is steered using only the biased brake torque, and a solid line shown in the graph of FIG. 7 indicates that the host vehicle is steered using the biased brake torque and the driving torque.

Referring to FIG. 7, first, when it is determined that the steering system 1 fails, the biased brake torque is applied to the braking system 120 according to a first steering angle of the steering wheel 11. In this case, as described above, the front brake torque and the rear brake torque may be different.

Then, a compensating driving torque (acceleration torque) to compensate for the driving torque reduced by the biased brake torque is applied to the driving system 130. Here, the compensation driving torque may be a value obtained by applying a weight to the biased brake torque as described above.

The biased brake torque and the driving torque increase from a point in time when the steering system 1 fails to a reference time. In this case, the vehicle speed of the host vehicle decreases, and the biased brake torque also decreases according to the reduced speed.

As illustrated in FIG. 7, when steering the host vehicle using only the biased brake torque and the driving torque, since the compensation driving torque is applied to compensate for the reduced driving torque, it may be confirmed that the speed of the host vehicle decreases more slowly compared to when steering the host vehicle using only the biased brake torque.

In this way, the driving assistance apparatus of a host vehicle according to the embodiment of the present disclosure may compensate for as much driving force as a longitudinal deceleration force of the host vehicle generated by the biased brake force to compensate for the longitudinal deceleration of the host vehicle, and furthermore, to allow a driver to experience natural deceleration without experiencing any discomfort and allow the driver to safely move the host vehicle to a target position.

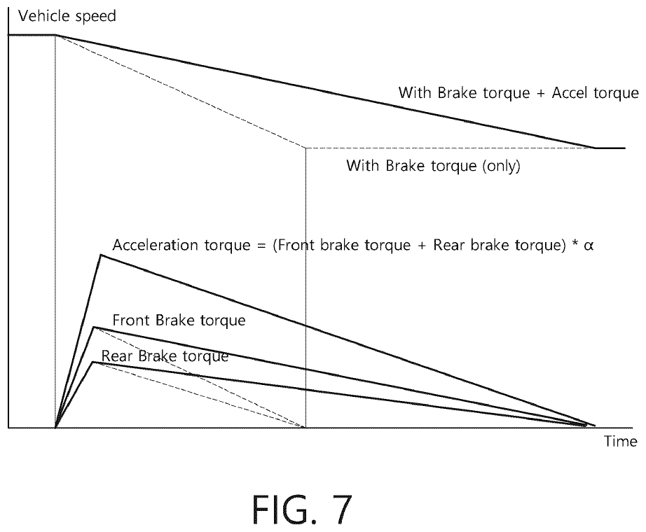

FIG. 8 is a graph for describing a method of setting a weight according to the speed of a host vehicle at a point in time when a steering system fails.

The controller 110 may differently set a weight α depending on the speed of the host vehicle at the point in time when the steering system 1 fails.

Referring to FIG. 8, the controller 110 may set a plurality of section speeds by dividing a speed of the host vehicle into sections and decrease the weight α as the plurality of section speeds increase.

Specifically, at the point in time when the steering system 1 fails, the speed of the host vehicle may be divided into a low speed section (Low speed), a medium speed section (Med speed), and a high speed section (High speed), and the weight α may be reduced for each of the low speed section, the medium speed section, and the high speed section.

This is because at the point in time when the steering system 1 fails, the greater the speed of the host vehicle, the more driving force there is to move the host vehicle to a target position.

The controller 110 may be communicatively connected to the third sensor 30 and may determine the target position of the host vehicle based on an object in front of the host vehicle. Here, the controller 110 may determine the target position (e.g., a shoulder) based on a front image of the host vehicle detected by the third sensor 30.

The controller 110 may set the weight α based on the target position. Here, the controller 110 may increase the weight α as a distance between the host vehicle and the target position increases.

This is for ensuring that the host vehicle reaches the target position by increasing the weight α since the longer the distance, the more driving force is required for the host vehicle to reach the target position.

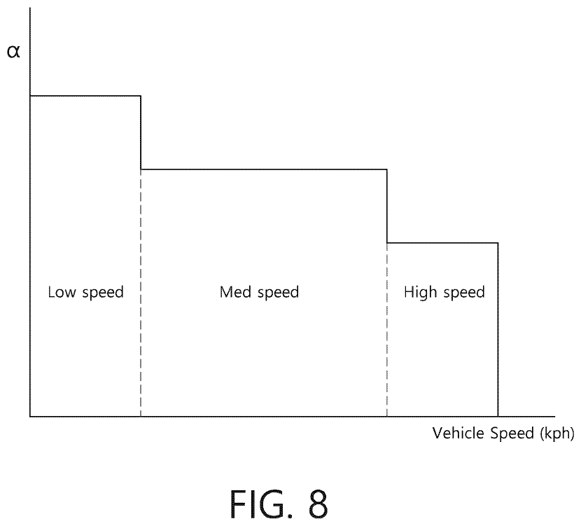

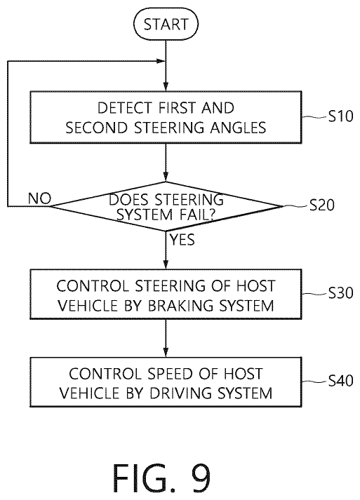

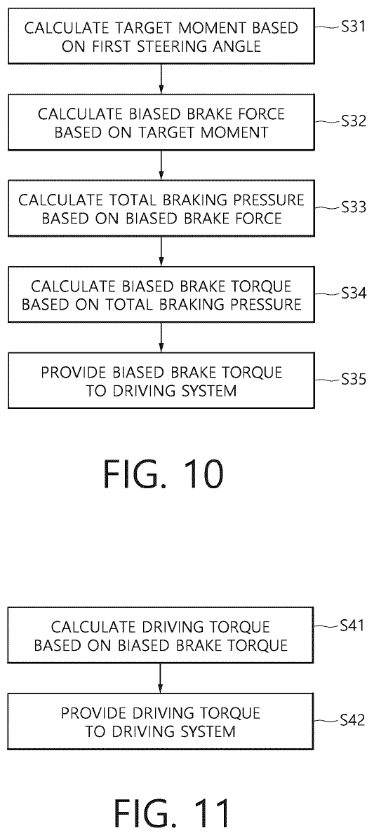

FIG. 9 is a flowchart of a method of assisting a driver of a host vehicle according to an embodiment of the present disclosure, FIG. 10 is a specific flowchart of an operation of controlling steering of a host vehicle by a braking system in FIG. 9, and FIG. 11 is a specific flowchart of an operation of controlling the speed of the host vehicle by a driving system in FIG. 9.

Hereinafter, with reference to FIGS. 9 to 11, the method of assisting a driver of a host vehicle according to the embodiment of the present disclosure will be described, but some of the same contents as those described above will be omitted.

Referring to FIG. 9, the method of assisting a driver of a host vehicle according to the embodiment of the present disclosure first detects a first steering angle of the steering wheel 11 of the host vehicle and then detects a second steering angle of the front wheels of the host vehicle or the position of the rack 22 of the steering system 1 (S10).

Next, based on the first steering angle of the steering wheel 11 and the second steering angle of the front wheels, a determination as to whether the steering system 1 of the host vehicle fails is made. Alternatively, the determination as to whether the steering system 1 of the host vehicle fails may also be made based on the first steering angle of the steering wheel 11 and the position of the rack 22 of the steering system 1.

Next, based on the determination that the steering system 1 fails, the host vehicle may be steered with a biased brake torque by the braking system 120 (S30).

Specifically, referring to FIG. 10, when the steering system 1 fails, a target moment of the host vehicle is calculated based on the first steering angle of the steering wheel (S31), and the biased brake force is calculated based on the target moment (S32).

Next, a total braking pressure is calculated based on the biased brake force (S33), and the controller 110 calculates the biased brake torque based on the total braking pressure Pb (S34).

Next, the calculated biased brake torque is provided to the braking controller 121 (S35).

Accordingly, the braking controller 121 steers the host vehicle by controlling a braking device according to the biased brake torque.

In this way, the method of assisting a driver of a host vehicle according to the embodiment of the present disclosure may implement redundancy and prevent accidents by steering the host vehicle using the biased brake force of the braking system 120 when the steering system 1 fails, and since there is no need to additionally provide a redundancy actuator to implement redundancy, there is an advantage in terms of cost.

Meanwhile, when steering the host vehicle by applying the biased brake force, a vehicle moment is generated, but since longitudinal deceleration of the host vehicle occurs due to the biased brake force, the speed of the host vehicle quickly decelerates compared to steering in a normal state.

Accordingly, the host vehicle having a broken steering system 1 may not move much and stops and thus may not reach a target point (e.g., a shoulder) and may cause a rear-end collision with another vehicle.

In order to solve the problem, the present disclosure provides the method of assisting a driver of a host vehicle that compensates for the driving force reduced due to the biased brake force when steering the host vehicle using the biased brake force.

To this end, when steering the host vehicle using the biased brake force, the driving torque of the host vehicle reduced due to the biased brake torque may be compensated for by controlling the speed of the host vehicle by the driving system 130 (S40).

Specifically, referring to FIG. 11, first, a driving torque is calculated based on the biased brake torque calculated based on the first steering angle of the steering wheel 11 (S41).

Here, the driving torque may be calculated by applying a weight to the biased brake torque.

In addition, the weight α may be differently set depending on the speed of the host vehicle at a point in time when steering system 1 fails. Here, a plurality of section speeds are set by dividing a speed of the host vehicle into sections, and the weight α may be reduced as the plurality of section speeds increase.

In addition, a target position (e.g., a shoulder) may be determined based on a front image of the host vehicle, and the weight α may be set based on the determined target position. Here, the longer a distance between the host vehicle and the target position, the greater the weight α may be.

Next, the driving torque is provided to the driving system 130 (S42). Accordingly, the driving controller 131 of the driving system 130 may control the speed of the host vehicle based on the driving torque.

In this way, the method of assisting driving of a host vehicle according to the embodiment of the present disclosure may compensate for as much driving force as a longitudinal deceleration force of the host vehicle generated by the biased brake force to compensate for the longitudinal deceleration of the host vehicle, and furthermore, to allow a driver to experience natural deceleration without experiencing any discomfort and allow the driver to safely move the host vehicle to the target position.

According to the present disclosure, by steering a host vehicle using a biased brake force of a braking system when a steering system fails, redundancy can be implemented and accidents can be prevented, and since there is no need to additionally provide a redundancy actuator to implement redundancy, there is an advantage in terms of cost.

According to the present disclosure, by compensating for as much driving force as a longitudinal deceleration force of a host vehicle generated by a biased brake force, the longitudinal deceleration of the host vehicle can be compensated for, and furthermore, a driver can experience natural deceleration without experiencing any discomfort, and the driver can safely move the host vehicle to a target position.

Effects of the present disclosure are not limited to the above-described effects, but should be understood to include all effects that can be deduced from features of disclosures described in the detailed description or the claims of the present disclosure.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. An apparatus for assisting driving of a host vehicle, the apparatus comprising:
a first sensor configured to detect a steering angle of a steering wheel of the host vehicle; and
a controller connected to the first sensor,
wherein the controller is configured to, in response to a determination of a failure of a steering system of the host vehicle, steer the host vehicle with a biased brake torque and compensate for a driving torque of the host vehicle, that is reduced due to the biased brake torque.

2. The apparatus of claim 1, wherein the controller is further configured to calculate the biased brake torque based on the steering angle, and transmit a first signal including information about the biased brake torque to a braking system of the host vehicle.

3. The apparatus of claim 2, wherein the braking system is configured to steer the host vehicle based on the biased brake torque.

4. The apparatus of claim 2, wherein the controller is further configured to calculate the driving torque based on the biased brake torque, and provide a second signal including information about the driving torque to a driving system of the host vehicle.

5. The apparatus of claim 4, wherein the driving system is configured to control a speed of the host vehicle based on the driving torque.

6. The apparatus of claim 4, wherein the controller is further configured to calculate the driving torque by applying a weight to the biased brake torque.

7. The apparatus of claim 6, wherein the controller is further configured to differently determine the weight depending on a speed of the host vehicle.

8. The apparatus of claim 6, wherein the controller is further configured to determine a plurality of section speeds by dividing a speed of the host vehicle into sections, and decrease the weight as the plurality of section speeds increase.

9. The apparatus of claim 6, further comprising:
a second sensor configured to detect an object in front of the host vehicle.

10. The apparatus of claim 9, wherein the controller is connected to the second sensor, and is configured to determine a target position of the host vehicle based on the object in front of the host vehicle.

11. The apparatus of claim 10, wherein the controller is further configured to determine the weight based on the target position.

12. The apparatus of claim 10, wherein the controller is further configured to increase the weight as a distance between the host vehicle and the target position increases.

13. The apparatus of claim 1, wherein the controller is further configured to:
calculate a target moment of the host vehicle based on the steering angle;
calculate a biased brake force based on the target moment;
calculate a total braking pressure based on the biased brake force; and
calculate a biased brake torque based on the total braking pressure.

14. The apparatus of claim 13, wherein the controller is further configured to calculate the driving torque based on the biased brake torque.

15. The apparatus of claim 1, wherein the steering system is a steer-by-wire system.

16. A method of assisting driving of a host vehicle, the method comprising:
determining whether a steering system of the host vehicle fails; and
in response to a determination of a failure of the steering system of the host vehicle, steering the host vehicle with a biased brake torque, and compensating for a driving torque of the host vehicle, that is reduced due to the biased brake torque.

17. The method of claim 16, wherein the steering of the host vehicle comprises:
calculating a target moment of the host vehicle based on a steering angle of a steering wheel of the host vehicle;
calculating a biased brake force based on the target moment;
calculating a total braking pressure based on the biased brake force;
calculating a biased brake torque based on the total braking pressure; and
transmitting a first signal including information about the biased brake torque to a braking system.

18. The method of claim 17, wherein the compensating for the driving torque of the host vehicle comprises:
calculating the driving torque based on the biased brake torque; and
providing a second signal including information about the driving torque to a driving system of the host vehicle.

19. The method of claim 18, wherein the calculating of the driving torque comprises calculating the driving torque by applying a weight to the biased brake torque.

20. The method of claim 19, wherein the calculating of the driving torque further comprises:
determining a plurality of section speeds by dividing a speed of the host vehicle into sections; and
decreasing the weight as the plurality of section speeds increase.
